(19) United States
(12) Patent Application Publication
(10) Pub. No.: US 2018/0014074 A1
(43) Pub. Date: Jan. 11, 2018

(54) Method and Apparatus for Playing a Multimedia File From a Re-Positioned Playing Point

(71) Applicant: TENCENT TECHNOLOGY (SHENZHEN) COMPANY LIMITED, Shenzhen (CN)

(72) Inventor: Chenxi Li, Shenzhen (CN)

(21) Appl. No.: 15/711,313

(22) Filed: Sep. 21, 2017

Related U.S. Application Data
(63) Continuation of application No. PCT/CN2016/085812, filed on Jun. 15, 2016.

(30) Foreign Application Priority Data
Jul. 21, 2015 (CN) 201510433499.X

(51) Int. Cl. H04N 21/472; G06F 17/30

(52) U.S. Cl. CPC H04N 21/47217; G06F 17/30044

(57) ABSTRACT

The present disclosure provides a method for playing a multimedia file from a re-positioned playing point, including: receiving a jump instruction, obtaining a re-positioned playing point specified by the jump instruction; obtaining a subtitle time axis of a current multimedia file, wherein the subtitle time axis records a start point of each subtitle of the multimedia file; in a jump direction specified by the jump instruction, searching start points recorded by the subtitle time axis for a start point which is closest to the re-positioned playing point as an actual re-positioned playing point; and playing the multimedia file from the actual re-positioned playing point. The present disclosure also provides an apparatus for playing multimedia file from a re-positioned playing point.

### CROSS REFERENCE TO RELATED APPLICATIONS

This application is a continuation of International Application No. PCT/CN2016/085812, filed on Jun. 15, 2016. This application claims the benefit and priority of Chinese Patent Application No. 201510433499.X, filed Jul. 21, 2015. The entire disclosures of each of the above applications are incorporated herein by reference.

### FIELD OF THE DISCLOSURE

The present disclosure relates to multimedia techniques, and more particularly, to a method and an apparatus for playing a multimedia file from a re-positioned playing point.

### BACKGROUND OF THE DISCLOSURE

At present, users may drag a progress bar or click a shortcut button to play forward or backwards when watching a video via a video player or listening to music via an audio player. For the progress bar, the playing point of the video or audio may be dragged backwards or forward for any time length. The time length is determined based on the distance that the progress bar is dragged. For the shortcut button, the playing point of the video or audio may be moved forward or backwards for a fixed time length, and the time length may be determined based on a predefined value, e.g., 5 seconds, 10 seconds, etc.

### SUMMARY OF THE DISCLOSURE

Examples of the present disclosure provide a method and an apparatus for playing a multimedia file from a re-positioned playing point, so as to play the multimedia file from a start point of a line of dialogue of the video or a start point of a line of lyric of the audio after a jump forward or jump backwards operation, and facilitate the user to continue to watch the video or listen to the audio.

Examples of the present disclosure provide a method for playing a multimedia file from a re-positioned playing point. The method includes:

receiving a jump instruction, obtaining a re-positioned playing point specified by the jump instruction;

obtaining a subtitle time axis of a current multimedia file, wherein the subtitle time axis records a start point of each subtitle of the multimedia file;

in a jump direction specified by the jump instruction, searching start points recorded by the subtitle time axis for a start point which is closest to the re-positioned playing point as an actual re-positioned playing point; and

playing the multimedia file from the actual re-positioned playing point.

Examples of the present disclosure also provide a non-transitory computer-readable storage medium. The non-transitory computer-readable storage medium includes instruction modules executable by one or more processors, the instruction modules comprise:

an instruction receiving module, to receive a jump instruction;

an obtaining module, to obtain a re-positioned playing point specified by the jump instruction, obtain a subtitle time axis of a current multimedia file, wherein the subtitle time axis records a start point of each subtitle of the multimedia file;

a searching module, to search, in a jump direction specified by the jump instruction, start points recorded by the subtitle time axis for a start point closest to the current playing point as an actual re-positioned playing point; and

a playing module, to play the current multimedia file from the actual re-positioned playing point.

Examples of the present disclosure further provide an apparatus for playing a multimedia file from a re-positioned playing point. The apparatus includes:

one or more processors;

memory; and

machine-readable instructions stored in the memory and to be executed by the one or more processors to perform acts of:

receiving a jump instruction, obtaining a re-positioned playing point specified by the jump instruction;

obtaining a subtitle time axis of a current multimedia file, wherein the subtitle time axis records a start point of each subtitle of the multimedia file;

in a jump direction specified by the jump instruction, searching start points recorded by the subtitle time axis for a start point which is closest to the re-positioned playing point as an actual re-positioned playing point; and

playing the multimedia file from the actual re-positioned playing point.

### BRIEF DESCRIPTION OF THE DRAWINGS

FIG. 1 is a schematic diagram illustrating a terminal where the apparatus for playing multimedia file from a re-positioned playing point is located according to some examples of the present disclosure;

FIG. 2 is a flowchart illustrating a method for playing multimedia file from a re-positioned playing point according to a first example of the present disclosure;

FIG. 3 is a flowchart illustrating a method for playing multimedia file from a re-positioned playing point according to a second example of the present disclosure;

FIG. 4 is a flowchart illustrating a method for playing multimedia file from a re-positioned playing point according to a third example of the present disclosure;

FIG. 5 is a flowchart illustrating a method for playing multimedia file from a re-positioned playing point according to a fourth example of the present disclosure;

FIG. 6 is a schematic diagram illustrating modules of the apparatus for playing multimedia file from a re-positioned playing point according to some examples of the present disclosure;

FIG. 7a is a schematic diagram illustrating a progress of playing multimedia file from a re-positioned playing point according to conventional techniques;

FIG. 7b is a schematic diagram illustrating a progress of playing multimedia file from a re-positioned playing point according to some examples of the present disclosure; and

FIG. 8 is a schematic diagram illustrating a subtitle time axis of the multimedia file according to some examples of the present disclosure.

The objective, features and merits of the present disclosure will be described in further detail with reference to the examples and the accompanying drawings of the present disclosure.

### DETAILED DESCRIPTION OF THE DISCLOSURE

It should be noted that, the examples described herein are merely used for explain the present disclosure but not used for restricting the present disclosure.

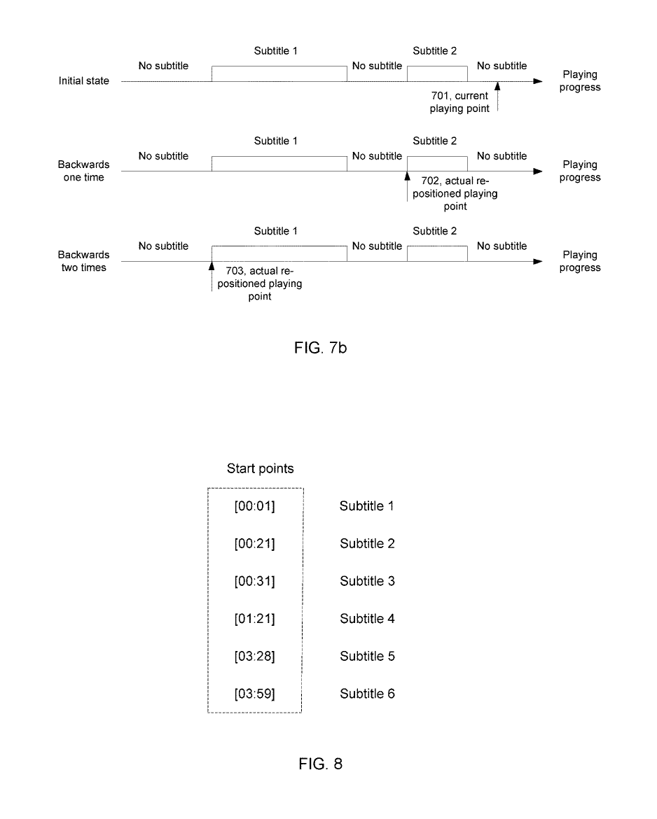

In a multimedia file seeking solution, when implementing fast forward or fast backwards via a shortcut key, a video or audio player moves a playing point forward or backwards for a fixed length (e.g., 5 seconds or 10 seconds), as shown in FIG. 7a. The current playing point is at time point 701. At this time, a user triggers a fast backwards operation via a shortcut button. The playing point moves backwards to time point 702. If the user triggers the fast backwards operation again, the playing time is moved backwards again to the time point 703, i.e., the playing starts from halfway of subtitle 1.

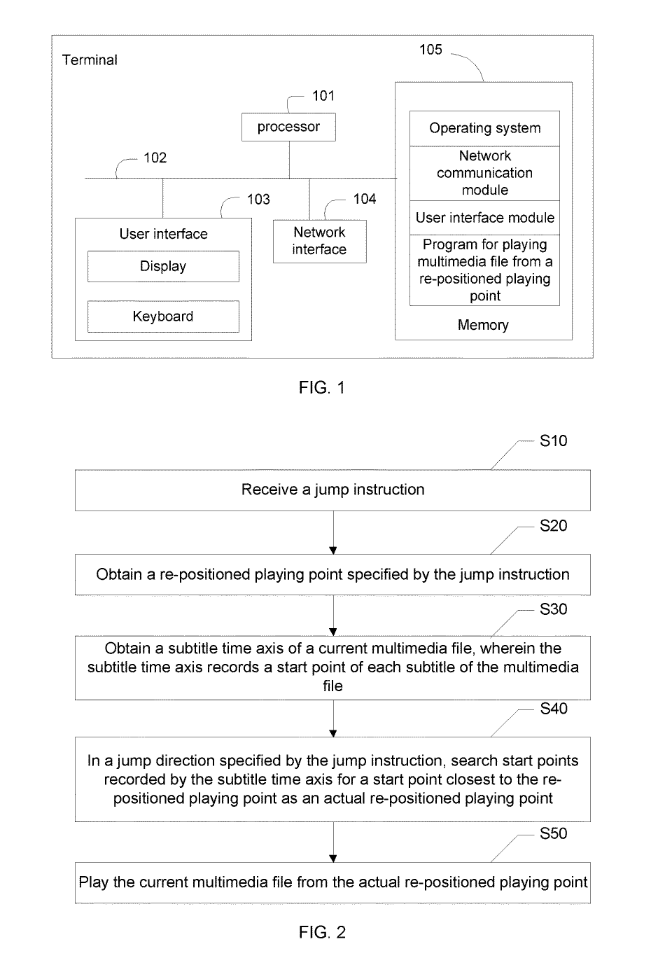

FIG. 1 is a schematic diagram illustrating a terminal where the apparatus for playing multimedia file from a re-positioned playing point is deployed according to some examples of the present disclosure. As shown in FIG. 1, the terminal may include: at least one processor 101, such as a CPU, at least one network interface 104, a user interface 103, a memory 105, and at least one communication bus 102. The communication bus 102 is to realize the connections and communications between the above components. The user interface 103 may include a display, a keyboard, and may include a standard wired interface and a wireless interface. The network interface 104 may include a standard wired interface and a wireless interface (e.g., WiFi interface). The memory 105 may be a high-speed RAM memory, or a non-volatile memory, e.g., at least one disk memory. The memory 105 may also be a storage apparatus remote from the processor 101. As a computer storage medium, the memory 105 may include an operating system, a network communication module, a user interface module and a program for playing multimedia file from a re-positioned playing point.

In the terminal that the apparatus for playing multimedia file from a re-positioned playing point is deployed as shown in FIG. 1, the network interface 104 is mainly used for implement connection with a server or another terminal and communicating with the server or the other terminal. The user interface 103 is mainly used for receiving a user instruction and interacting with the user. The processor 101 may execute the program for playing multimedia file from a re-positioned playing point stored in the memory 105 to perform acts of:

receiving a jump instruction via the user interface 103;

obtaining a re-positioned playing point indicated by the jump instruction;

obtaining a subtitle time axis of a current multimedia file, wherein the subtitle time axis records a start point of each subtitle of the multimedia file;

in a jump direction indicated by the jump instruction, searching different start points recorded in the subtitle time axis for a start point closest to the re-positioned playing point as an actual re-positioned playing point; and

playing the multimedia file from the actual re-positioned playing point.

In some examples, when the current multimedia file is a video file, the subtitle time axis records the start point of each subtitle of dialogues of the video file. When the current multimedia file is an audio file, the subtitle time axis records the start point of each subtitle of lyrics of the audio file.

In some examples, the processor 101 executes the program for playing multimedia file from a re-positioned playing point stored in the memory 105 to perform acts of:

when the jump instruction indicates to jump forward, searching the start points recorded in the subtitle time axis for a start point which is later than the current playing point and is closest to the re-positioned playing point as the actual playing point; and

when the jump instruction indicates to jump backwards, searching the start points recorded in the subtitle time axis for a start point which is earlier than the current playing point and is closest to the re-positioned playing point as the actual re-positioned playing point.

In some examples, the processor 101 executes the program for playing multimedia file from the re-positioned playing point stored in the memory 105 to perform the acts of:

when the jump instruction is generated via dragging a progress bar, obtaining a time point corresponding to the dragged progress bar as the re-positioned playing point.

In some examples, the processor 101 executes the program for playing multimedia file from the re-positioned playing point stored in the memory 105 to perform the acts of:

when the jump instruction is generated via a shortcut key, obtaining a predefined fixed time length;

when the jump instruction indicates to jump forward, obtaining the re-positioned playing point by adding the predefined fixed time length to the current playing point;

when the jump instruction indicates to jump backwards, obtaining the re-positioned playing point by subtracting the predefined fixed time length from the current playing point.

According to the apparatus for playing multimedia file from the re-positioned playing point illustrated in FIG. 1 and the terminal where it is located, in response to the jump operation to the multimedia file, the video data or audio data is played from the start point of a subtitle of the video or the start point of a subtitle of a lyric of the audio, which avoids to seek to the middle to a subtitle or a lyric. As such, the user is able to listen to a complete line of dialogue or lyric after the jump operation, which facilitates the user to watch the video or listen to the audio.

FIG. 2 is a flowchart illustrating a method for playing multimedia file from a re-positioned playing point according to some examples of the present disclosure. As shown in FIG. 2, the method for playing multimedia file from a re-positioned playing point provided by the examples of the present disclosure includes the following:

In step S10, a jump instruction is received.

In some examples, the method may be applicable for a video player or an audio player, or a browser for playing multimedia file online. When a user wants to seek to a particular point, the user may trigger a jump instruction via one of the following: dragging a progress bar of the current video or audio via a mouse or a touchscreen to a particular position, or clicking a shortcut button, e.g., clicking a left arrow key on the keyboard for fast backwards and a right arrow key for fast forward, or clicking an operation control for fast forward or fast backwards displayed on the player.

In step S20, a re-positioned playing point indicated by the jump instruction is obtained.

The jump instruction indicates a re-positioned playing point, e.g., if the user drags a progress bar to a specified position, the specified position is the re-positioned playing point indicated by the jump instruction. For another example, if the user clicks a right arrow key of the keyboard, the point ahead of the current playing time for a predefined length is the re-positioned playing point indicated by the jump instruction.

In block S30, a subtitle time axis of the current multimedia file is obtained, wherein the subtitle time axis records a start time of each subtitle of the multimedia file.

The user may configure a functionality for adjusting re-positioned playing point according to subtitle in the player in advance. After the re-positioned playing point is obtained, instead of seeking to the time and playing the audio or video data, the player adjusts the re-positioned playing point to a start time of the subtitle of a dialogue or a start point of a song lyric. At this time, the player needs to obtain the subtitle time axis of the current multimedia file. If the current multimedia file is a video file, the subtitle time axis records the start time of each subtitle of the dialogues of the video file, as shown in FIG. 8. Similarly, if the current multimedia file is an audio file, the subtitle time axis records the start time of each subtitle of the song lyrics.

At block S40, in the direction indicated by the jump instruction, among various start points recorded by the subtitle time axis, a start point closest to the re-positioned playing point is found and taken as an actual re-positioned playing point.

The subtitle time axis as shown in FIG. 8 is taken as an example. Suppose that the current playing point is 01:00. If the jump direction indicated by the jump instruction is jump forward, and the re-positioned playing point indicated by the jump instruction is 01:10, in the subtitle time axis as shown in FIG. 8, the start point closest to 01:10 is 01:21. Then, 01:21 is taken as the actual re-positioned playing point. If the jump direction indicated by the jump instruction is jump backwards and the re-positioned playing point indicated by the jump instruction is 01:00, in the subtitle time axis as shown in FIG. 8, although the start point closest to 01:00 is 01:21, since 01:21 is not in the indicated jump direction, 01:21 is not taken as the actual re-positioned playing point. 00:31 is taken as the actual re-positioned playing point.

At block S50, the current multimedia file is played from the actual re-positioned playing point.

After the actual re-positioned playing point is obtained, the player plays the current multimedia file from the actual re-positioned playing point, as shown in FIG. 7b. As such, the video data is played from the start point of a certain dialogue of the current video file after the jump operation, or the audio data is played from the start point of a certain lyric, which avoids playing the audio or video from the middle of one dialogue in the video or one lyric in the audio. The user is able to listen to a complete line of dialogue or lyric in the multimedia file after the jump operation, which facilitates the user to watch the video or listen to the audio.

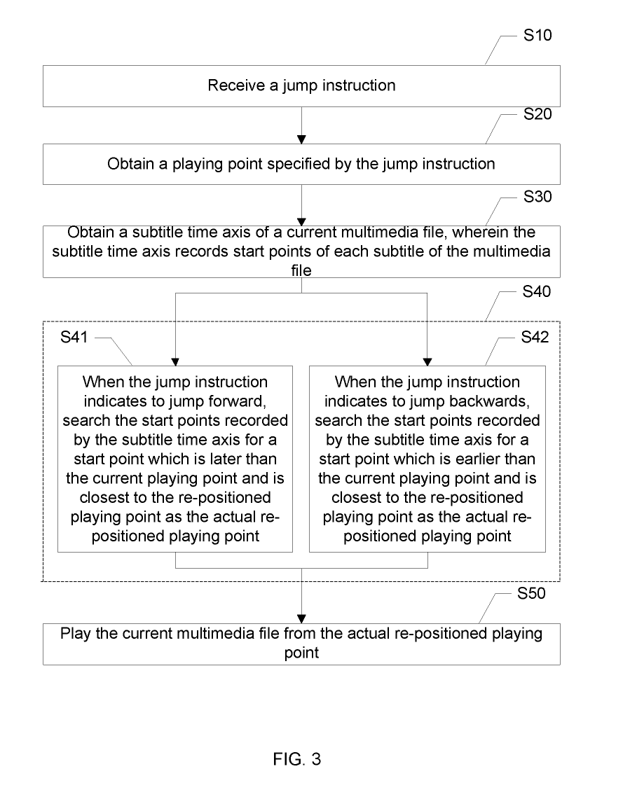

FIG. 3 is a flowchart illustrating a method for playing a multimedia file from a re-positioned playing point according to some examples of the present disclosure.

At block S10, a jump instruction is received.

At block S20, a re-positioned playing point indicated by the jump instruction is obtained.

At block S30, a subtitle time axis of a current multimedia file is obtained, wherein the subtitle time axis records a start point of each subtitle of the multimedia file.

At block S41, if the jump instruction is jump forward, the start points recorded by the subtitle time axis are searched for a start point later than the current playing point and closest to the re-positioned playing point, and the found start point is taken as the actual re-positioned playing point.

At block S42, if the jump instruction is jump backwards, the start points recorded by the subtitle time axis are searched for a start point which is earlier than the current playing point and closest to the re-positioned playing point, and the found start point is taken as the actual re-positioned playing point.

At block S50, the current multimedia file is played from the actual re-positioned playing point.

In the examples of the present disclosure, the player compares the re-positioned playing point indicated by the jump instruction and the current playing point, and determines a jump direction. If the re-positioned playing point indicated by the jump instruction is later than the current playing point, the jump direction indicated by the jump instruction is jump forward. If the re-positioned playing point indicated by the jump instruction is earlier than the current playing time, it indicates that the jump direction specified by the jump instruction is jump backwards. The start point of the subtitle of a dialogue in the subtitle time axis of the video file or the start point of the subtitle of a lyric in subtitle time axis of the audio file is compared with the current playing point. If the start point is later than the current playing point, the start point is in the forward direction of the current playing process. If the start point is earlier than the current playing point, the start point is in a backwards direction of the current playing process. For example, suppose that the current playing point is 01:00. If the jump instruction is jump forward and the re-positioned playing point indicated by the jump instruction is 01:10. In the subtitle time axis as shown in FIG. 8, a start point later than 01:00 and closest to 01:10 is the start point 01:21. Thus, 01:21 is taken as the actual re-positioned playing point. If the jump instruction indicates jump backwards and the re-positioned playing point specified by the jump instruction is 01:00. In the subtitle time axis as shown in FIG. 8, although start point 01:21 is closest to 01:00, since 01:21 is later than the current playing point 01:00, 01:21 is not taken as the actual re-positioned playing point. Instead, 00:31 is selected as the actual playing point. In the examples of the present disclosure, the start point in the subtitle time axis is compared with the current playing point to determine whether the start point closest to the specified playing point is in the jump direction. Thus, the jump operation becomes more accurate and it is avoided to jump to a reverse direction of the actual jump direction.

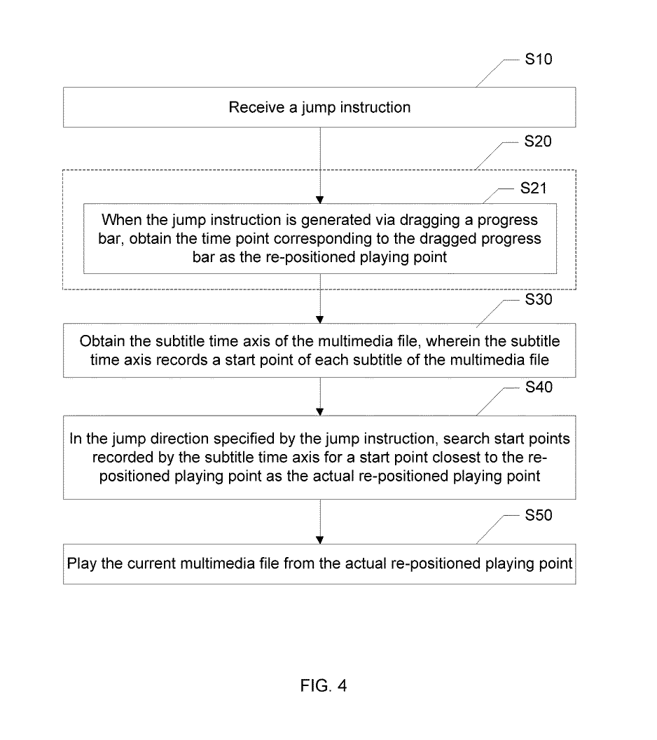

FIG. 4 is a flowchart illustrating a method for playing a multimedia file from a re-positioned playing point according to some examples of the present disclosure.

At block S10, a jump instruction is received.

At block S21, if the jump instruction is generated via dragging a progress bar, a time point corresponding to the dragged progress bar is obtained as a specified playing point.

At block S30, a subtitle time axis of the current multimedia file is obtained, wherein the subtitle time axis records a start point of each subtitle of the multimedia file.

At block S40, in the jump direction specified by the jump instruction, the start points recorded by the subtitle time axis are searched for a start point closest to the specified playing point as the actual re-positioned playing point.

At block S50, the current multimedia file is played from the actual re-positioned playing point.

In this example, the jump instruction is generated via dragging the progress bar. The length of the progress bar of the current multimedia file corresponds to the whole time length of the multimedia file. Each point on the progress bar corresponds to a playing time. The user drags the progress bar to a particular point via mouse or touchscreen. The particular position corresponds to time point acting as the re-positioned playing point specified by the jump instruction. After determining the re-positioned playing point specified by the jump instruction, instead of playing the multimedia file from the re-positioned playing point, the player adjusts re-positioned playing point according to the start point of respective subtitle of dialogues in the subtitle time axis of the current video or the start point of respective subtitle of lyrics in the subtitle time axis of the current audio, such that the player may play the video data or audio data from the start point of a dialogue of a video or a lyric of an audio, and avoids playing from the middle of a dialogue or a lyric. Thus, the user is able to listen to a complete line of dialogue or lyric after the jump operation. It is convenient for the user to continue to watch the video or listen to the audio.

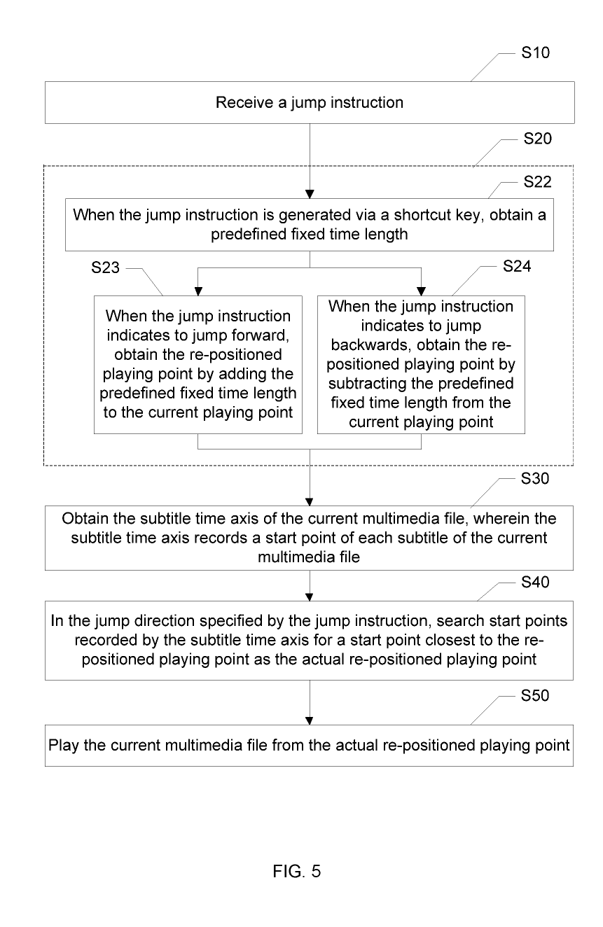

FIG. 5 is a flowchart illustrating a method for playing a multimedia file from a re-positioned playing point according to some examples of the present disclosure.

At block S10, a jump instruction is received.

At block S22, if the jump instruction is generated via a shortcut key, a predefined fixed time length is obtained.

At block S23, if the jump instruction is jump forward, a specified playing point is obtained by adding the predefined fixed time length to the current playing point.

At block S24, if the jump instruction is jump backwards, a specified playing point is obtained by subtracting the predefined fixed time length from the current playing point.

At block S30, a subtitle time axis of the current multimedia file is obtained, wherein the subtitle time axis records a start point of each subtitle of the multimedia file.

At block S40, in the jump direction specified by the jump instruction, the start points recorded by the subtitle time axis are searched for a start point closest to the specified playing point as the actual re-positioned playing point.

At block S50, the current multimedia file is played from the actual re-positioned playing point.

In this example, the jump instruction is generated via a shortcut key. The shortcut key may be a physical key on a keyboard or a mouse, e.g., a left arrow key on the keyboard corresponds to a backwards operation, and the right arrow key corresponds a forward operation. The shortcut key may also be a virtual control displayed on a screen, e.g., an operation control for play forward or backwards displayed by a player. The player is also configured with a fixed time length for the jump operation of the shortcut key. For example, the current playing point is 01:00, and the fixed time length is 5 s. If the user clicks the backwards shortcut key for one time, the current playing point jumps back for 5 s, i.e., the specified playing point is 00:55. If the user clicks the forward shortcut key for one time, the current playing point jumps ahead for 5 s, i.e., the specified playing time is 01:05. After determining the re-positioned playing point specified by the jump instruction, instead of playing the multimedia file from the re-positioned playing point, the player adjusts the re-positioned playing point according to the start point of each dialogue recorded in the subtitle time axis of the current video or the start point of each lyric recorded in the subtitle time axis of the current audio. As such, the video data or audio data can be played from the start point of a dialogue of the video or a lyric of the audio after the jump operation. It is avoided that the multimedia file is played from the middle of a dialogue or a lyric. Thus, the user is able to listen to a complete line of dialogue or lyric after the jump operation, which facilitates the user to watch the video or listen to the audio.

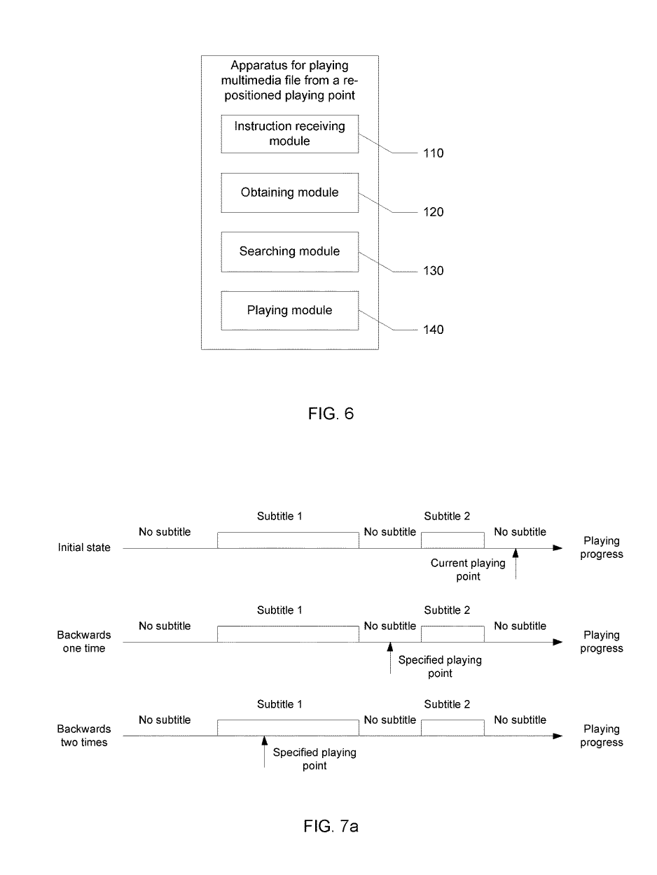

FIG. 6 is a schematic diagram illustrating modules of an apparatus for playing a multimedia file from a re-positioned playing point according to some examples of the present disclosure. The apparatus includes:

an instruction receiving module 110, to receive a jump instruction;

an obtaining module 120, to obtain a re-positioned playing point specified by the jump instruction, obtain a subtitle time axis of a current multimedia file, wherein the subtitle time axis records a start point of each subtitle of the multimedia file;

a searching module 130, to search, in the jump direction indicated by the jump instruction, the start points recorded by the subtitle time axis for a start point closest to the re-positioned playing point as an actual re-positioned playing point; and

a playing module 140, to play the current multimedia file from the actual re-positioned playing point.

The example of the present disclosure is applicable for a video player or an audio player, or a browser for playing multimedia file on line. When the user wants to seek to a particular point, it is possible to trigger the jump instruction via one of the following: dragging a progress bar to a designated position via mouse or touchscreen; clicking a shortcut key, e.g., clicking a left arrow key on the keyboard for jumping backwards, clicking a right arrow key on the keyboard for jumping forward, or clicking an operation control for jumping backwards or forward displayed on the player.

The jump instruction contains a re-positioned playing point. For example, if the user drags the progress bar to a designated position, the designated position is the re-positioned playing point specified by the jump instruction. For another example, if the user clicks a left arrow key on the keyboard, the re-positioned playing point specified by the jump instruction is the current playing point moving back for a predefined time length.

The user may configure a functionality for adjusting the re-positioned playing point according to the subtitle in the player in advance. Thus, after the specified playing point is obtained, the player does not directly play the audio or video data from the re-positioned playing point, but adjusts the re-positioned playing point to the start point of a dialogue or lyric. At this time, the player needs to obtain the subtitle time axis of the current multimedia file. If the current multimedia file is a video file, the subtitle time axis records a start point of each subtitle of dialogues of the current video file, as shown in FIG. 8. If the current multimedia file is an audio file, the subtitle time axis records a start point of each subtitle of lyrics of the audio file.

The subtitle time axis as shown in FIG. 8 is taken as an example. Suppose that the current playing point is 01:00. If the jump direction indicated by the jump instruction is jump forward, and the re-positioned playing point indicated by the jump instruction is 01:10, in the subtitle time axis as shown in FIG. 8, the start point 01:21 is closest to 01:10. Thus, 01:21 is taken as the actual re-positioned playing point. If the jump direction indicated by the jump instruction is jump backwards and the re-positioned playing point indicated by the jump instruction is 01:00, in the subtitle time axis as shown in FIG. 8, although the start point 01:21 is closest to 01:00, since 01:21 is not in the jump direction, 01:21 is not taken as the actual re-positioned playing point. Instead, 00:31 is taken as the actual re-positioned playing point.

After the actual re-positioned playing point is obtained, the player plays the current multimedia file from the actual re-positioned playing point, as shown in FIG. 7b. Thus, the video data is played from the start point of a dialogue after the jump operation, or the audio data is played from the start point of lyric of the audio file after the jump operation. It is avoided that the multimedia file is played from the middle of one dialogue or lyric. The user is able to listen to a complete line of dialogue or lyric, which facilitates the user to continue to watch the video or listen to the audio.

In some examples, the searching module 130 may be further to:

if the jump instruction indicates to jump forward, search the start points recorded by the subtitle time axis, for a start point later than a current playing point and closest to the re-positioned playing point as an actual re-positioned playing point; and

if the jump instruction indicates to jump backwards, search the start points recorded by the subtitle time axis, for a start point earlier than the current playing point and closest to the re-positioned playing point as the actual re-positioned playing point.

In the examples of the present disclosure, the player compares the re-positioned playing point indicated by the jump instruction with the current playing point to determine the jump direction corresponding to the jump instruction. If the re-positioned playing point indicated by the jump instruction is later than the current playing point, it indicates that the jump direction corresponding to the jump instruction is jump forward; if the re-positioned playing point indicated by the jump instruction is earlier than the current playing point, it indicates that the jump direction corresponding to the jump instruction is jump backwards. In the examples of the present disclosure, the start point of the subtitle in the subtitle time axis of the video file or the start point of lyric in the subtitle time axis of the audio file is compared with the current playing point. If the start point is later than the current playing point, the start point is in the forward direction of the current playing process. If the start point is earlier than the current playing point, the start point is in a backwards direction of the current playing process. For example, the current playing point is 01:00. If the jump instruction indicates to jump forward and the re-positioned playing point indicated by the jump instruction is 01:10, in the subtitle time axis as shown in FIG. 8, the start point ahead of 01:00 and closest to 01:10 is 01:21. Thus, 01:21 is taken as the actual re-positioned playing point. If the jump instruction indicates to jump backwards and the re-positioned playing point indicated by the jump instruction is 01:00, in the subtitle time axis as shown in FIG. 8, although the start point 01:21 is closest to 01:00, since 01:21 is later than the current playing point, 01:21 is not taken as the actual re-positioned playing point. Instead, 00:31 is taken as the actual re-positioned playing point. In the examples of the present disclosure, the current playing point and the start point in the subtitle time axis are compared to determine whether the start point closest to the indicated re-positioned playing point is in the jump direction indicated by the jump instruction, so as to make the jump operation more accurate and avoids to jump to a reverse direction to the actual jump direction.

In some examples, the obtaining module 120 is further to:

if the jump instruction is generated via dragging a progress bar, obtain a time point corresponding to the dragged progress bar as the designated re-positioned playing point.

In some examples of the present disclosure, the jump instruction may be generated via dragging a progress bar. The length of the progress bar of the current multimedia file corresponds to the whole time length of the multimedia file. Each point on the progress bar corresponds to a playing time. The user drags the progress bar to a particular point via mouse or touchscreen. The particular position corresponds to time point acting as the re-positioned playing point specified by the jump instruction. After determining the re-positioned playing point specified by the jump instruction, instead of playing the multimedia file from the re-positioned playing point, the player adjusts re-positioned playing point according to the start point of respective subtitle of dialogues in the subtitle time axis of the current video or the start point of respective subtitle of lyrics in the subtitle time axis of the current audio, such that the player may play the video data or audio data from the start point of a dialogue of a video or a lyric of an audio, and avoids playing from the middle of a dialogue or a lyric. Thus, the user is able to listen to a complete line of dialogue or lyric after the jump operation. It is convenient for the user to continue to watch the video or listen to the audio.

In some examples, the obtaining module 120 may be further to:

when the jump instruction is generated via a shortcut key, obtain a predefined fixed time length;

when the jump instruction indicates jump forward, obtain the re-positioned playing point by adding the predefined fixed time length to the current playing point; and

when the jump instruction indicates to jump backwards, obtain the re-positioned playing point by subtracting the predefined fixed time length from the current playing point.

In this example, the jump instruction is generated via a shortcut key. The shortcut key may be a physical key on a keyboard or a mouse, e.g., a left arrow key on the keyboard corresponds to a backwards operation, and the right arrow key corresponds a forward operation. The shortcut key may also be a virtual control displayed on a screen, e.g., an operation control for play forward or backwards displayed by a player. The player is also configured with a fixed time length for the jump operation of the shortcut key. For example, the current playing point is 01:00, and the fixed time length is 5 s. If the user clicks the backwards shortcut key for one time, the current playing point jumps back for 5 s, i.e., the specified playing point is 00:55. If the user clicks the forward shortcut key for one time, the current playing point jumps ahead for 5 s, i.e., the specified playing time is 01:05. After determining the re-positioned playing point specified by the jump instruction, instead of playing the multimedia file from the re-positioned playing point, the player adjusts the re-positioned playing point according to the start point of each dialogue recorded in the subtitle time axis of the current video or the start point of each lyric recorded in the subtitle time axis of the current audio. As such, the video data or audio data can be played from the start point of a dialogue of the video or a lyric of the audio after the jump operation. It is avoided that the multimedia file is played from the middle of a dialogue or a lyric. Thus, the user is able to listen to a complete line of dialogue or lyric after the jump operation, which facilitates the user to watch the video or listen to the audio.

It should be noted that, in the present disclosure, the words “include”, “comprise” and variations are to be interpreted inclusively. That is, these words are intended to convey the possible inclusion of other elements or integers not specifically recited, where the context allows. Without prejudice to more restrictions, the element restricted by “including a . . . ” does not exclude the situation of inclusion of other same elements in the process, method, product or apparatus including the element.

Based on the above, those with ordinary skill in the art may clearly know that the method of the present disclosure may be implemented via software and necessary universal hardware platform or through hardware. But in most cases, the former is better. Based on this, the technical solution of the present disclosure in essence or the contributing part may be implemented by a software product. The software product is stored in a storage medium (such as ROM/RAM, disk, compact disk), including a set of instructions enable a terminal device (such as cellphone, computer, server or network device, etc.) to execute the method provided by the examples of the present disclosure.

What has been described and illustrated herein is an example of the disclosure along with some of its variations. The terms, descriptions and figures used herein are set forth by way of illustration. Many variations are possible within the spirit and scope of the disclosure, which is intended to be defined by the following claims and their equivalents.

1. A method for playing a multimedia file from a re-positioned playing point, comprising:
receiving a jump instruction, obtaining a re-positioned playing point specified by the jump instruction;
obtaining a subtitle time axis of a current multimedia file, wherein the subtitle time axis records a start point of each subtitle of the multimedia file;
in a jump direction specified by the jump instruction, searching start points recorded by the subtitle time axis for a start point which is closest to the re-positioned playing point as an actual re-positioned playing point; and
playing the multimedia file from the actual re-positioned playing point.

2. The method of claim 1, wherein when the current multimedia file is a video file, the subtitle time axis records the start point of each subtitle of dialogues of the video file.

3. The method of claim 1, wherein the multimedia file is an audio file, the subtitle time axis records the start point of each subtitle of lyrics of the audio file.

4. The method of claim 1, wherein in the jump direction specified by the jump instruction, searching the start points recorded by the subtitle time axis for the start point which is closest to the re-positioned playing point as the actual re-positioned playing point comprises:
when the jump instruction indicates to jump forward, searching the start points recorded by the subtitle time axis for the start point which is later than a current playing point and closest to the re-positioned playing point as the actual re-positioned playing point.

5. The method of claim 1, wherein in the jump direction specified by the jump instruction, searching the start points recorded by the subtitle time axis for the start point which is closest to the re-positioned playing point as the actual re-positioned playing point comprises:
when the jump instruction indicates to jump backwards, searching the start points recorded by the subtitle time axis for the start point which is earlier than the current playing point and closest to the re-positioned playing point as the actual re-positioned playing point.

6. The method of claim 1, wherein the obtaining the re-positioned playing point specified by the jump instruction comprises:
when the jump instruction is generated via dragging a progress bar, obtaining a time point corresponding to the dragged progress bar as the re-positioned playing point.

7. The method of claim 1, wherein the obtaining the re-positioned playing point specified by the jump instruction comprises:
when the jump instruction is generated via a shortcut key, obtaining a predefined fixed time length;
when the jump instruction indicates to jump forward, obtaining the re-positioned playing point by adding the predefined fixed time length to the current playing point; and
when the jump instruction indicates to jump backwards, obtaining the re-positioned playing point by subtracting the predefined fixed time length from the current playing point.

8. A non-transitory computer-readable storage medium, comprising: instruction modules executable by one or more processors, the instruction modules comprise:
an instruction receiving module, to receive a jump instruction;
an obtaining module, to obtain a re-positioned playing point specified by the jump instruction, obtain a subtitle time axis of a current multimedia file, wherein the subtitle time axis records a start point of each subtitle of the multimedia file;
a searching module, to search, in a jump direction specified by the jump instruction, start points recorded by the subtitle time axis for a start point closest to the current playing point as an actual re-positioned playing point; and
a playing module, to play the current multimedia file from the actual re-positioned playing point.

9. The non-transitory computer-readable storage medium of claim 8, wherein when the current multimedia file is a video file, the subtitle time axis records the start point of each subtitle of dialogues of the video file.

10. The non-transitory computer-readable storage medium of claim 8, wherein when the current multimedia file is an audio file, the subtitle time axis records the start point of each subtitle of lyrics of the audio file.

11. The non-transitory computer-readable storage medium of claim 8, wherein the searching module is further to:
when the jump instruction indicates to jump forward, search the start points recorded by the subtitle time axis for a start point which is later than the current playing point and is closest to the re-positioned playing point as the actual re-positioned playing point.

12. The non-transitory computer-readable storage medium of claim 8, wherein the searching module is further to:
when the jump instruction indicates to jump backwards, search the start points recorded by the subtitle time axis for a start point which is earlier than the current playing point and is closest to the re-positioned playing point as the actual re-positioned playing point.

13. The non-transitory computer-readable storage medium of claim 8, wherein the obtaining module is further to:
when the jump instruction is generated via dragging a progress bar, obtain a time point corresponding to the dragged progress bar as the re-positioned playing point.

14. The non-transitory computer-readable storage medium of claim 8, wherein the obtaining module is further to:
when the jump instruction is generated via a shortcut key, obtain a predefined fixed time length;
when the jump instruction indicates to jump forward, obtain the re-positioned playing point by adding the predefined fixed time length to the current playing point; and
when the jump instruction indicates to jump backwards, obtain the re-positioned playing point by subtracting the predefined fixed time length from the current playing point.

15. An apparatus for playing a multimedia file from a re-positioned playing point, comprising:
one or more processors;
memory; and
machine-readable instructions stored in the memory and to be executed by the one or more processors to perform acts of:
receiving a jump instruction, obtaining a re-positioned playing point specified by the jump instruction;
obtaining a subtitle time axis of a current multimedia file, wherein the subtitle time axis records a start point of each subtitle of the multimedia file;
in a jump direction specified by the jump instruction, searching start points recorded by the subtitle time axis for a start point which is closest to the re-positioned playing point as an actual re-positioned playing point; and
playing the multimedia file from the actual re-positioned playing point.

16. The apparatus of claim 15, wherein when the current multimedia file is a video file, the subtitle time axis records the start point of each subtitle of dialogues of the video file.

17. The apparatus of claim 15, wherein when the multimedia file is an audio file, the subtitle time axis records the start point of each subtitle of lyrics of the audio file.

18. The apparatus of claim 15, wherein in the jump direction specified by the jump instruction, searching the start points recorded by the subtitle time axis for the start point which is closest to the re-positioned playing point as the actual re-positioned playing point comprises:
when the jump instruction indicates to jump forward, searching the start points recorded by the subtitle time axis for the start point which is later than a current playing point and closest to the re-positioned playing point as the actual re-positioned playing point;
when the jump instruction indicates to jump backwards, searching the start points recorded by the subtitle time axis for the start point which is earlier than the current playing point and closest to the re-positioned playing point as the actual re-positioned playing point.

19. The apparatus of claim 15, wherein the obtaining the re-positioned playing point specified by the jump instruction comprises:
when the jump instruction is generated via dragging a progress bar, obtaining a time point corresponding to the dragged progress bar as the re-positioned playing point.

20. The apparatus of claim 15, wherein the obtaining the re-positioned playing point specified by the jump instruction comprises:
when the jump instruction is generated via a shortcut key, obtaining a predefined fixed time length;
when the jump instruction indicates to jump forward, obtaining the re-positioned playing point by adding the predefined fixed time length to the current playing point; and
when the jump instruction indicates to jump backwards, obtaining the re-positioned playing point by subtracting the predefined fixed time length from the current playing point.
